(19) United States
(12) Patent Application Publication
(10) Pub. No.: US 2026/0308949 A1
(43) Pub. Date: Oct. 8, 2026

(54) MOTOR VEHICLE LOCK

(71) Applicant: Kiekert Aktiengesellschaft, Heiligenhaus (DE)

(72) Inventor: Armin HANDKE, Duisburg (DE)

(73) Assignee: Kiekert Aktiengesellschaft, Heiligenhaus (DE)

(21) Appl. No.: 19/106,259

(22) PCT Filed: Aug. 16, 2023
(86) PCT No.: PCT/DE2023/100601

§ 371 Date: Feb. 25, 2025

(30) Foreign Application Priority Data
Aug. 26, 2022 (DE) 10 2022 121 657.8

(51) Int. Cl. E05B 81/06; E05B 81/14; E05B 81/16

(52) U.S. Cl. CPC E05B 81/06; E05B 81/14; E05B 81/16

(57) ABSTRACT

The invention relates to a motor vehicle lock, in particular a motor vehicle door lock, which is equipped with a locking mechanism (I, 2) substantially comprising a rotary latch (I) and a pawl (2). A first electromotive drive (4, 5, 6) at least for opening the locking mechanism (I, 2) and for acting on a first coupling element (7) is also realised. Furthermore, a second electromotive drive (10, 11) for acting on a second coupling element (12) is provided. According to the invention, the first electromotive drive (4, 5, 6), when opening the locking mechanism (I, 2), simultaneously works on a blocking slide (11), acting on the second coupling element (12), in the manner of a freewheel.

The invention relates to a motor vehicle lock, in particular a motor vehicle door lock, with a latching mechanism consisting essentially of a rotary latch and a detent pawl, additionally with a first electromotive actuator at least for opening the latching mechanism and for applying force to a first coupling element, and with a second electromotive actuator for applying force to a second coupling element.

Motor vehicle locks and, in particular, motor vehicle door locks of the prior art are used in different variants and in a wide range of positions within and on a motor vehicle. In fact, these include hatchback locks, front hood locks, gas tank flap locks, and even seat adjustment locks. In general, said motor vehicle locks, and in particular motor vehicle door locks, are produced on the side doors of motor vehicles.

At this position, electromotive actuators for opening the latch mechanism, in other words electromotive opening actuators, are often utilized. Use of the latter is increasing for reasons of convenience and acoustics. The latching mechanism comprising a rotary latch and detent pawl, when in the locked position, can be opened by aid of such electromotive opening actuators. To this end, the detent pawl is lifted, by aid of the electromotive actuator, away from its latching engagement with the rotary latch. As a result, the rotary latch opens, under spring tension, and releases a previously caught lock bar and thus the associated motor vehicle door.

However, in a crash or a loss of the electrical power supply of the electromotive actuator, emergency measures are required for opening the latch mechanism. For example, these may include opening an actuation lever chain on an emergency basis in case of a crash. To this end, the actuation lever chain in question is shifted into its “unlocked” position, which generally entails that the coupling element is in its “engaged” condition. The actuation lever chain is closed, so that, for example, arriving rescue personnel can open an associated motor vehicle door using an exterior door handle. This process is referred to as “temporary crash redundancy (TCR).”

That is to say, the actuation lever chain in question is generally open in normal operation. It is like this so that, for example while driving or even during a short stop of the motor vehicle, the associated motor vehicle door cannot be opened from the outside by unauthorized persons (for example at a red light). In normal operation, the electromotive actuator produces the electromotive opening. However, if emergency operation and consequently an emergency opening are necessary, for example in case of a crash, the actuation lever chain must be closed mechanically to enable a mechanically redundant opening of the latching mechanism. That can be done by aid of the first electromotive actuator or even the second electromotive actuator.

One such procedural method has proven its value fundamentally, as the groundbreaking patent DE 10 2019 132 764 A1 makes clear. In it, an electromotive actuator is produced that applies force to a safety element. By aid of the safety element, a safety mechanism can be steered into assuming its safety position. Along with this electromotive actuator, an electromotive opening actuator is additionally produced.

In comparable prior art according to EP 3 800 310 A1, a process is followed in which the electromotive actuator acts on the latch mechanism in an opening direction to open it and applies force to a safety lever in a different safety-release direction to make it assume its safety-release position.

In addition, a stop is provided for the electromotive actuator, which, at least when force is applied to it, limits the motion of the electromotive actuator in the opening direction to clear the safety-release position. In this way, opening of the latching mechanism is prevented.

The state of the art has generally retained its value when it comes, first, to the realization of an electromotive opening actuator, and second, to the implementation of temporary crash redundancy (i.e., limited timewise normally to opening in an emergency). However, from this starting basis, further requirements emerge in practice. Namely, in previous embodiments, the fundamental problem arises that the second actuation lever chain (interior actuation lever chain) typically associated with the second electromotive actuator blocks electromotive opening when force is applied manually. Such scenarios arise in practice when, for example, an associated motor vehicle is opened by electromotive means, not from the outside, but from the inside and at the same time as an interior door handle is pulled by a backseat passenger. Under certain circumstances, that leads to irritation and reduced comfort which must be dealt with.

The invention is based on the technical problem of developing a motor vehicle lock of this kind, particularly a motor vehicle door lock, such that the operation of it is facilitated in general and such that opening by electromotive means is possible at all times.

To solve this technical problem, the invention proposes, for a generic motor vehicle lock, and in particular a motor vehicle door lock, that, when opening the latching mechanism, the first electromotive actuator simultaneously acts by freewheel motion on a blocking traveler that applies force to the second coupling element.

According to the invention, therefore, when the latching mechanism is opened by aid of the first electromotive actuator, it automatically happens that any possible blockages of a second actuation lever chain usually associated with the second coupling element will be removed and eliminated by freewheel motion. In other words, the first electromotive actuator typically assigned to the first actuation lever chain, when opening the latching mechanism, simultaneously causes any blockages of the second actuation lever chain to be eliminated by freewheel motion.

The first actuation lever chain is generally an exterior actuation lever chain. The first electromotive actuator logically provides, on the one hand, for the opening of the latching mechanism, and on the other hand, for the possibility of a force being applied to the first coupling element as a component of this first actuation lever chain or exterior actuation lever chain. When the described electromotive opening occurs, the first electromotive actuator in the opening of the latching mechanism usually acts not only on a release lever but at the same time on the second coupling element as a component of the second actuation lever chain or interior actuation lever chain. For in the described process of opening the latching mechanism, the first electromotive actuator causes a blocking traveler, as a component of the second actuation lever chain, to have a force applied to it by aid of it by freewheel motion. The blocking traveler, for its part, generally acts on the second coupling element as a component of the second actuation lever chain or interior actuation lever chain.

In any case, this design according to the invention ensures that, when the latching mechanism is opened by electromotive means by aid of the first electromotive actuator, any blockages of the second actuation lever chain, and in particular interior actuation lever chain, are overcome by freewheel motion.

If therefore, as an example, a user applies force to the second actuation lever chain or interior actuation lever chain by pulling the interior door handle, according to the invention this will be harmless in any process of opening the latching mechanism by aid of the first electromotive actuator, because the first electromotive actuator simultaneously provides for the desired freewheel in the second actuation lever chain, that is, any blockage of the electromotive actuator due to interior actuation lever chain being pulled or having force applied to it will be eliminated. In this, its significant advantages can be seen.

In order to achieve this in detail, the first electromotive actuator normally has a setting element with at least one freewheel arm. The freewheel arm can act reciprocally with a shoulder on the blocking traveler. Thus, as soon as the freewheel arm runs against the shoulder on the blocking traveler in the context of the opening of the latching mechanism due to application of force by the first electromotive actuator, this leads to the blocking traveler being pivoted out of its position in which it was blocking the electromotive opening process or the second actuation lever chain.

In fact, the blocking traveler typically has a blocking nose for an actuation lever that is equipped with the second coupling element. When the actuation lever is pivoted outward, the blocking nose is in adjoining contact with a blocking contour of the actuation lever. In other words, if the actuation lever in question as a component of the second actuation lever chain were pivoted outward or had a force applied to it, a blockage would occur between the blocking contour on the respective actuation lever and the blocking nose on the blocking traveler. This blockage is cleared, according to the invention, as soon as the first electromotive actuator for opening the latching mechanism has a force applied to it and removes the blockage by simultaneously applying force to the blocking traveler.

If no blockage were present, naturally it would not be necessary for the nonexistent blockage to be eliminated, or to need to be eliminated by aid of the first electromotive actuator when the latching mechanism is opened.

Either way, when the latching mechanism is opened, the first electromotive actuator causes the blocking traveler, as a component of the second actuation lever chain, to be released from any blocking position it may have taken, so as to apply force to the second coupling element. In this blocking position, the blocking traveler with its blocking nose is in adjoining contact with the blocking contour of the actuation lever in question as a component of the second actuation lever chain. The respective actuation lever, as a component of the second actuation lever chain, is typically an interior actuation lever as a component of the already mentioned second actuation lever chain or interior actuation lever chain.

By aid of the first electromotive actuator, the first coupling element as a component of the first actuation lever chain or exterior actuation lever chain can be selectively shifted into the “engaged” and “disengaged” positions. The “engaged” position of the first coupling element corresponds to the first actuation lever chain or the exterior actuation lever chain being mechanically closed. In contrast, the “disengaged” position of the first coupling element corresponds to the first actuation lever chain or the exterior actuation lever chain being mechanically open.

The setting element of the first electromotive actuator is normally equipped with a peg, along with the freewheel arm for applying force to the shoulder of the blocking traveler. The peg generally acts on a release lever in one rotary direction of the setting element and on a transfer lever in the other rotary direction of the setting element.

That is to say, the first electromotive actuator in one rotary direction causes a force to be applied to the release lever via the peg on the setting element. The latching mechanism can be opened via the release lever under applied force. This is because the release lever lifts the detent pawl away from its engagement with the rotary latch in the locked position of the latching mechanism.

If, on the other hand, the setting element has force applied to it in the other rotary direction, then the peg on the setting element causes the transfer lever controlling the first coupling element as well as the first coupling element itself to have force applied to them.

The blocking traveler is generally equipped with a spring applying force to it, making it assume its base position. Since the blocking traveler has force applied to it in the case of an electromotive opening process and an additional blockage of the actuation lever or interior actuation lever of the second actuation lever chain or interior actuation lever chain by freewheel motion, it comes about in this case that the spring is compressed during the respective freewheel motion of the blocking traveler. After the termination of the freewheel motion, the spring then causes the blocking traveler to be moved back into its base position.

As a result, a motor vehicle lock, and in particular a motor vehicle door lock, is provided and produced that enables problem-free electromotive opening even when the second actuation lever chain, for example, has force applied to it manually and this normally would lead to a blockage of the first electromotive actuator. This generally corresponds to an interior door handle pulled by a user, which corresponds to the application of force to the respective interior actuation lever as a component of the interior actuation lever chain or second actuation lever chain.

So as to be able, in such a case, to open the associated motor vehicle door by electromotive means nonetheless, it is provided according to the invention that the first electromotive actuator when opening the latching mechanism acts simultaneously on a blocking traveler that applies force to the second coupling element as a component of the second actuation lever chain or interior actuation lever chain by freewheel motion. In this way, the blockage of the first electromotive actuator or the second actuation lever chain or interior actuation lever chain is removed by freewheel motion and the first electromotive actuator can open the latching mechanism as planned without any blockage. All that is achieved while allowing for a functionally appropriate, compact and simply-designed structure. In this, its significant advantages can be seen.

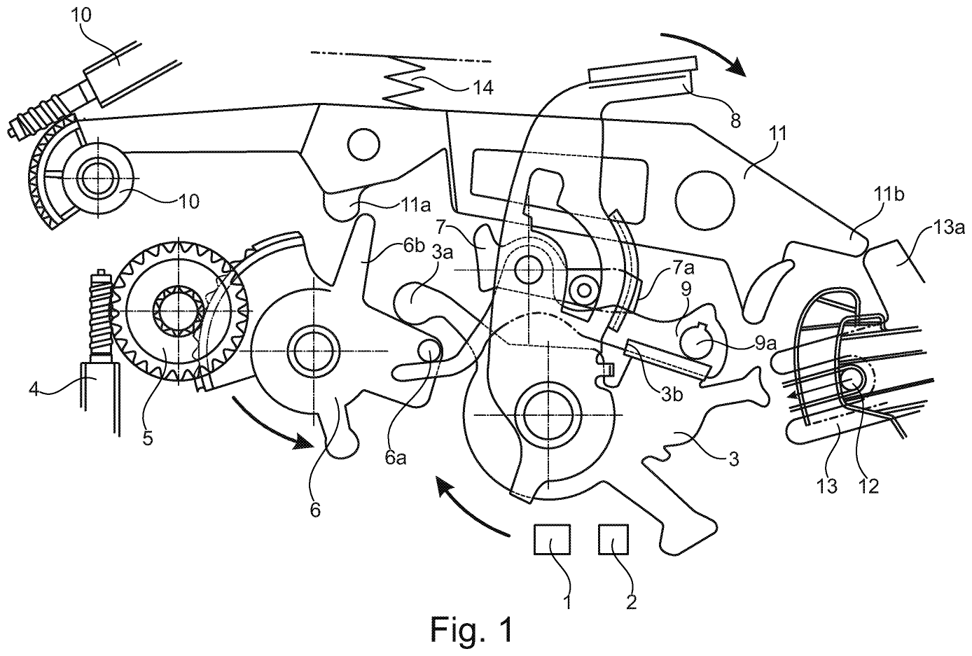

The invention is described below in detail based on a drawing depicting only one embodiment; the single FIG. 1 shows the inventive motor vehicle lock reduced to the individual parts that are material for the following observations.

The single FIG. 1 depicts a motor vehicle lock designed as a motor vehicle door lock. The motor vehicle lock in question has a latching mechanism 1, 2, consisting essentially of a rotary latch 1 and detent pawl 2, which is depicted schematically in the locked position. In FIG. 1, one can see that latching mechanism 1, 2 is extended in a plane perpendicular to the plane of the drawing. Application of force to a release lever 3 in the clockwise direction around its axis, as indicated in FIG. 1, leads to detent pawl 2 being lifted away from its latching engagement with rotary latch 1. After that, rotary latch 1 opens, under spring tension, and releases a previously caught lock bar and thus the associated motor vehicle door.

To initiate the described clockwise rotation of release lever 3 and consequently to open latching mechanism 1, 2 by electromotive means, a first electromotive actuator 4, 5, 6 is provided.

First electromotive actuator 4, 5, 6 comprises an electric motor 4, a downstream gearwork 5 and a setting element 6 on the output side. By aid of setting element 6, release lever 3 can then be pivoted around its axis in the direction of the described clockwise movement. For this purpose, setting element 6 completes a counterclockwise rotary movement as indicated in FIG. 1.

As a result, a peg 6a provided on setting element 6 acts on an arm 3a of release lever 3, and thereby pivots release lever 3 as a whole in the clockwise direction as indicated in FIG. 1. As a consequence of this, detent pawl 2 in the locked position of latching mechanism 1, 2 is lifted away from its latching engagement with rotary latch 1 and can open latching mechanism 1, 2 as a whole.

According to the invention, electromotive actuator 4, 5, 6 already described above is set up and designed not only at least [sic] for opening latching mechanism 1, 2. Rather, according to the embodiment, first electromotive actuator 4, 5, 6 in question is also able and designed to apply force to a first coupling element 7. First coupling element 7 is part of a first actuation lever chain 7, 8, which not only has first coupling element 7 but also has in addition an actuation lever or exterior actuation lever 8. First coupling element 7 is mounted in a pivoting manner on actuation lever 8. Actuation lever or exterior actuation lever 8 in turn in positioned in a pivoting manner on the same axis as release lever 3.

To apply force to first coupling element 7, a transfer lever 9 is provided, mounted on a housing. When setting element 6 has force applied to it in the clockwise direction by aid of electromotive actuator 4, 5, 6, then peg 6a on setting element 6 causes transfer lever 9 to be pivoted counterclockwise around its axis, and by that means, causes first coupling element 7 with its peg indicated in FIG. 1 to be conveyed along a recess into the lowest position within this recess.

In this way, coupling element 7 with a front edge 7a comes to engage with a stop 3b on release lever 3. As a result of this, a clockwise pivoting movement of actuation lever or exterior actuation lever 8 around its axis shared with release lever 3 makes it possible for release lever 3 to be carried along by means of intervening first coupling element 7 in order to be able to open latching mechanism 1, 2, which is in the locked position.

First electromotive actuator 4, 5, 6 can have force applied to it in a first direction to open latching mechanism 1, 2. Associated with this is a counterclockwise rotation of setting element 6, which by means of peg 6a and actuation arm 3a causes release lever 3 to pivot clockwise. If, on the other hand, setting element 6 undergoes an application of force in the opposite actuation direction, namely clockwise, then this causes first coupling element 7 to be “engaged” by aid of first electromotive actuator 4, 5, 6. In fact, FIG. 1 shows the “disengaged” condition of the respective first coupling element 7.

In order to shift the latter into the “engaged” position, it is necessary for setting element 6 to rotate clockwise, so that transfer lever 9 is pivoted counterclockwise around its axis 9a by means of peg 6a and first coupling element 7 rotates clockwise around the axis on actuation lever or exterior actuation lever 8, so that the peg visible there assumes its lowest position in the associated recess. Then, in a clockwise pivoting movement of actuation lever or exterior actuation lever 8 around the axis shared with release lever 3, actuation lever 8 with mediation by first coupling element 7 can carry along release lever 3, mounted on the same axis, in the clockwise direction, so that latching mechanism 1, 2 can be opened.

For in this process, edge 7a runs up against stop 3b.

If, on the other hand, coupling element 7 is in the “disengaged” condition depicted in FIG. 1, a clockwise pivoting movement of actuation lever or exterior actuation lever 8 leads to release lever 3 not being carried along. Corresponding operations of actuation lever 8 consequently have no effect in relation to latching mechanism 1, 2.

In addition to first electromotive actuator 4, 5, 6 already described in detail above, the inventive motor vehicle lock, and in particular motor vehicle door lock, is also equipped with a second electromotive actuator 10, 11. Second electromotive actuator 10, 11 has for this purpose a pivoting setting member 10, which acts in turn on a connected blocking traveler 11. By aid of blocking traveler 11 and thus of second electromotive actuator 10, 11, force can then be applied to a second coupling element 12.

Second coupling element 12 is a coupling slide that is mounted in a linearly slideable manner on an actuation lever 13. Actuation lever 13 is part of a second actuation lever chain 12, 13, which is designed according to the embodiment as an interior actuation lever chain 12, 13. In contrast, first actuation lever chain 7, 8 already described above constitutes an exterior actuation lever chain 7, 8.

According to the invention, first electromotive actuator 4, 5, 6 when opening latching mechanism 1, 2 simultaneously causes first electromotive actuator 4, 5, 6 in question to act by freewheel motion on blocking traveler 11 that applies force to second coupling element 12.

To this end, first electromotive actuator 4, 5, 6, or its setting element 6, has at least one freewheel arm 6b. This freewheel arm 6b acts reciprocally with a shoulder 11a on blocking traveler 11.

If setting element 6 then makes a counterclockwise movement, so as to be able to open latching mechanism 1, 2 electrically or electromotively, then said freewheel arm 6b on setting element 6 runs up against shoulder 11a on the blocking traveler. This causes blocking traveler 11 connected in an articulated manner to setting member 10 to pivot counterclockwise around its axis on setting member 10 against the force of a spring 14. As a result, any blockage between a blocking nose 11b at the end of blocking traveler 11 and a blocking contour 13a of actuation lever 13 is eliminated.

In fact, the blockage of first electromotive actuator 4, 5, 6 in the described electromotive process of opening latching mechanism 1, 2 is observed and is present when—as depicted in FIG. 1—actuation lever 13 has a force applied to it in the counterclockwise direction to open latching mechanism 1, 2. This corresponds to the functional position of the respective actuation lever 13 in FIG. 1, which is an interior actuation lever 13 according to the embodiment. In any case, the pivoted-out position of the actuation lever in question, and in particular interior actuation lever 13, corresponds to its blocking contour 13a interacting reciprocally with blocking nose 11b of blocking traveler 11. Such a functional position is normally present when interior actuation lever 13 adopts the functional position depicted in FIG. 1 due to a user pulling an interior door handle.

In this blocking position of blocking traveler 11, force cannot be applied to first electromotive actuator 4, 5, 6 for the purpose of electromotive opening of latching mechanism 1, 2, because normally in this case the associated setting element 6 is blocked by a reciprocal interaction between second coupling element 12 or actuation lever 13 and release lever 3.

According to the invention, however, freewheel arm 6b on setting element 6 ensures that, by means of shoulder 11a on blocking traveler 11, blocking traveler 11 is released from its blockage position depicted in FIG. 1. This occurs against the force of spring 14. As a result of this, first electromotive actuator 4, 5, 6 can apply force to setting element 6 in the counterclockwise direction, so that release lever 3 is then pivoted by means of peg 6a in the clockwise direction indicated in FIG. 1, and in this way latching mechanism 1, 2 is opened as desired. In this process or in the freewheel operation of blocking traveler 11, spring 14 in question is compressed, because blocking traveler 11 pivots counterclockwise. That means that, after a return motion of first electromotive actuator 4, 5, 6 back to its starting position, compressed spring 14 causes blocking traveler 11 to return to its un-pivoted-out base position again.

By aid of second electromotive actuator 10, 11, second coupling element 12 as a component of second actuation lever chain 12, 13 can have force applied to it. However, that is not depicted in detail. In fact, FIG. 1 shows second coupling element 12 as a component of second actuation lever chain 12, 13 or interior actuation lever chain 12, 13 in its “disengaged” position. After all, the application of force to actuation lever or interior actuation lever 13 as indicated in FIG. 1 has no effect on release lever 3. On the other hand, if second coupling element 12 does not take its retracted position shown in FIG. 1, but rather takes its extended position with a corresponding projection beyond the front of actuation lever 13, then actuation lever 13 is in a position to pivot release lever 3 likewise in the clockwise direction to open latching mechanism 1, 2. However, that is not depicted in detail.

As explained, blocking traveler 11 causes coupling element 12 to take either the “engaged” or “disengaged” position, which in addition for this purpose have force applied to them by aid of setting member 10 as a component of second electromotive actuator 10, 11.

### LIST OF REFERENCE SIGNS

Rotary latch 1
Detent pawl 2
Latching mechanism 1, 2
Release lever 3
Arm 3a
Stop 3b
Electric motor 4
Gearwork 5
Setting element 6
Peg 6a
Freewheel arm 6b
Actuator 4, 5, 6
Coupling element 7
Edge 7a
Exterior actuation lever 8
Transfer lever 9
Axis 9a
Actuator 10, 11
Blocking traveler 11
Shoulder 11a
Blocking nose 11b
Coupling element 12
Actuation lever 13
Blocking contour 13a
Spring 14

1. A motor vehicle lock comprising,
a first coupling element,
a second coupling element,
a latching mechanism including:
a rotary latch and
a detent pawl,
a first electromotive actuator at least for opening the latching mechanism and for applying force to the first coupling element, and
a second electromotive actuator for applying force to the second coupling element, the second electromotive actuator including a blocking traveler,
wherein the first electromotive actuator when opening the latching mechanism simultaneously acts by a freewheel motion on the blocking traveler that applies force to the second coupling element.

2. The motor vehicle lock of claim 1, wherein the first electromotive actuator has a setting element with at least one freewheel arm.

3. The motor vehicle lock of claim 2, wherein the blocking traveler includes a shoulder, and wherein the at least one freewheel arm acts reciprocally with the shoulder of the blocking traveler.

4. The motor vehicle lock of claim 1, further comprising an actuation lever equipped with the second coupling element, wherein the blocking traveler has a blocking nose for the actuation lever.

5. The motor vehicle lock of claim 4, wherein the actuation lever includes a blocking contour, and wherein the blocking nose is in adjoining contact with the blocking contour of the actuation lever when the actuation lever is pivoted out.

6. The motor vehicle lock of claim 5, wherein the first electromotive actuator when opening the latching mechanism frees the blocking traveler along with the blocking nose adjoining the blocking contour.

7. The motor vehicle lock of claim 1, further comprising an actuation lever chain having an engaged position and a disengaged position, wherein the first electromotive actuator shifts the first coupling element selectively into an engaged position and a disengaged position of the actuation lever chain.

8. The motor vehicle lock of claim 2, further comprising a release leaver and a transfer lever,
wherein the transfer lever is configured to control the first coupling element,
wherein in addition to the at least one freewheel arm, the setting element of the first electromotive actuator is equipped with a peg, and
wherein the peg acts in one rotary direction on the release lever and in another rotary direction on the transfer lever.

9. The motor vehicle lock of claim 1, wherein the blocking traveler has a spring that applies force to cause the blocking traveler to assume a base position.

10. The motor vehicle lock of claim 9, wherein the spring is compressed during the freewheel motion of blocking traveler.

11. The motor vehicle lock of claim 8, wherein the latching mechanism is configured to be opened via the release lever.

12. The motor vehicle lock of claim 11, wherein the release lever is configured to lift the detent pawl away from the rotary latch in a locked position of the latching mechanism.

13. The motor vehicle lock of claim 9, wherein the spring is configured to cause the blacking traveler to be back in the base position when the wheel motion is complete.
